(19) United States
(12) Patent Application Publication
(10) Pub. No.: US 2023/0042712 A1
(43) Pub. Date: Feb. 9, 2023

(54) THERMAL INTERFACE MATERIAL AND METHOD AND COMPOSITION FOR PREPARING THE SAME

(71) Applicant: GTA MATERIAL CO., LTD., New Taipei City (TW)

(72) Inventor: Yung-Chi TSAI, New Taipei City (TW)

(21) Appl. No.: 17/853,146

(22) Filed: Jun. 29, 2022

(30) Foreign Application Priority Data
Jul. 8, 2021 (TW) 110125099

(51) Int. Cl. C09D 183/06; C09D 163/00; C09D 5/26; C09D 7/61; C08K 3/011; C08K 3/08; C08K 3/22

(52) U.S. Cl. CPC C09D 183/06; C09D 163/00; C09D 5/26; C09D 7/61; C08K 3/011; C08K 3/08; C08K 3/22; C08K 2003/0806; C08K 2003/0812; C08K 2003/0831; C08K 2003/085; C08K 2003/222; C08K 2003/2227; C08K 2003/2296; C08K 2201/001

(57) ABSTRACT

A thermal interface composition includes a polysiloxane component, a thermal conductive component, a curing agent, a curing accelerator, an organosilicon coupling agent, and a crosslinking agent having three or more epoxy groups. The polysiloxane component includes not lower than 50 wt % and lower than 100 wt % of a first polysiloxane and a second polysiloxane. The thermal conductive component includes not lower than 30 wt % and lower than 70 wt % of a first thermal conductive filler, not lower than 30 wt % and lower than 70 wt % of a second thermal conductive filler, and greater than 0 wt % and not greater than 40 wt % of a third thermal conductive filler. A method for preparing a thermal interface material is also disclosed.

### CROSS-REFERENCE TO RELATED APPLICATION

This application claims priority of Taiwanese Invention Patent Application No. 110125099, filed on Jul. 8, 2021.

### FIELD

The disclosure relates to a thermal interface composition and a thermal interface material prepared from the same. More particularly, the thermal interface material can return to its original state without deformation after being subjected to an external force, and can absorb the external force and protect a semiconductor chip from damage.

### BACKGROUND

FIGS. 1 to 2 respectively illustrate two embodiments of a conventional semiconductor device 1. As shown in FIG. 1, the heat energy generated by a semiconductor chip 11 disposed in the semiconductor device 1 can be dissipated through a heat dissipation element 12 disposed on the semiconductor chip 11. In addition, as shown in FIG. 2, the heat energy generated by the semiconductor chip 11 can be first transferred to a cover 13 disposed on the semiconductor chip 11, and then dissipated by the heat dissipation element 12 disposed on the cover 13. During a packaging process for the semiconductor device 1, in order to achieve the effect of heat dissipation and fixation, a thermal interface material 14 is usually disposed between the semiconductor chip 11 and the heat dissipation element 12, between the semiconductor chip 11 and the cover 13, or between the cover 13 and the heat dissipation element 12. The thermal interface material 14 has adhesiveness and thermal conductivity, and hence is capable of dissipating the heat energy generated by the semiconductor chip 11 and improving heat dissipation of the semiconductor device 1.

JP 2017071707 A discloses a liquid thermal conductive resin composition, which includes an epoxy resin, a curing agent, a curing accelerator, a thermal conductive filler, and thermoplastic resin particles. The liquid thermal conductive resin composition of JP 2017071707 A has high thermal conductivity, and good heat resistance and adhesion, however, the semiconductor device 1 is easily impacted by an external force in the subsequent manufacturing process, which might affect the adhesion between the thermal interface material 14 and the semiconductor chip 11, the heat dissipation element 12 or the cover 13, thereby reducing thermal conductivity.

Therefore, there is still a need to develop a thermal interface material that can return to its original state without deformation after being subjected to an external force, and that can absorb the external force and protect a semiconductor device from damage.

### SUMMARY

In a first aspect, the present disclosure provides a thermal interface composition, which can alleviate at least one of the drawbacks of the prior art.

The thermal interface composition includes: a polysiloxane component which includes a first polysiloxane having epoxy groups at opposite ends and a second polysiloxane having an epoxy group at one end, the first polysiloxane being present in an amount not lower than 50 wt % and lower than 100 wt %, based on the total weight of the polysiloxane component;

a thermal conductive component which includes, based on the total weight of the thermal conductive component, not lower than 30 wt % and lower than 70 wt % of a first thermal conductive filler that has a particle size greater than 1 μm and not greater than 10 μm, not lower than 30 wt % and lower than 70 wt of a second thermal conductive filler that has a particle size greater than 0.2 μm and not greater than 1 μm, and greater than 0 wt %, and not greater than 40 wt % of a third thermal conductive filler that has a particle size not greater than 0.2 μm;

a curing agent;

a curing accelerator;

an organosilicon coupling agent for improving the compatibility between the polysiloxane component and the thermally conductive component; and

a crosslinking agent having three or more epoxy groups.

The thermal conductive component is present in an amount not lower than 600 parts by weight and lower than 1500 parts by weight, and the crosslinking agent is present in an amount greater than 0.5 parts by weight and not greater than 0.9 parts by weight, based on 100 parts by weight of the polysiloxane component.

In a second aspect, the present disclosure provides a method for preparing a thermal interface material, which can alleviate at least one of the drawbacks of the prior art, and which includes subjecting the aforesaid thermal interface composition to a curing reaction.

In a third aspect, the present disclosure provides a thermal interface material, which can alleviate at least one of the drawbacks of the prior art, and which is prepared by the method as described above.

### BRIEF DESCRIPTION OF THE DRAWINGS

Other features and advantages of the disclosure will become apparent in the following detailed description of the embodiments with reference to the accompanying drawings, of which:

FIG. 1 is a schematic sectional view illustrating a first embodiment of a conventional semiconductor device; and

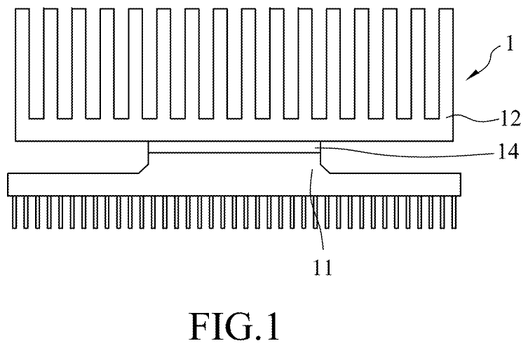

FIG. 2 is a schematic sectional view illustrating a second embodiment of the conventional semiconductor device.

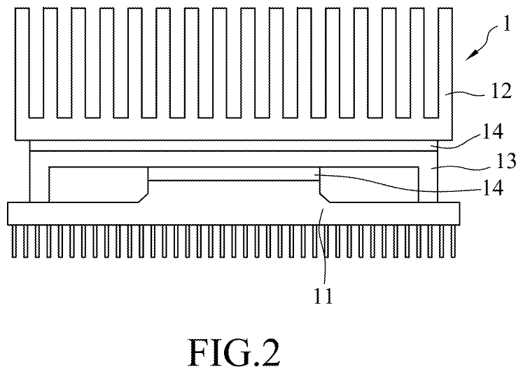

### DETAILED DESCRIPTION

### <Thermal Interface Composition>

The present disclosure provides a thermal interface composition, which includes:

a polysiloxane component;

a thermal conductive component;

a curing agent;

a curing accelerator;

an organosilicon coupling agent for improving the compatibility between the polysiloxane component and the thermal conductive component; and

a crosslinking agent having three or more epoxy groups.

The polysiloxane component includes a first polysiloxane having epoxy groups at opposite ends and a second polysiloxane having an epoxy group at one end. The first polysiloxane is present in an amount not lower than 50 wt % and lower than 100 wt %, based on a total weight of the polysiloxane component. The thermal conductive component includes, based on the total weight of the thermal conductive component, not lower than 30 wt % and lower than 70 wt % of a first thermal conductive filler that has a particle size greater than 1 μm and not greater than 10 μm, not lower than 30 wt % and lower than 70 wt % of a second thermal conductive filler that has a particle size greater than 0.2 μm and not greater than 1 μm, and greater than 0 wt % and not greater than 40 wt of a third thermal conductive filler that has a particle size not greater than 0.2 μm.

The thermal conductive component is present in an amount not lower than 600 parts by weight and lower than 1500 parts by weight, and the crosslinking agent is present in an amount greater than 0.5 parts by weight and not greater than 0.9 parts by weight, based on 100 parts by weight of the polysiloxane component.

### <Polysiloxane Component>

An example of the first polysiloxane may include, but is not limited to, a polysiloxane represented by formula (I):

R¹¹Si(R¹²)₂O[Si(R¹³)₂O]ₙSi(R¹⁴)₂R¹⁵ (I),

in which R¹¹ represents

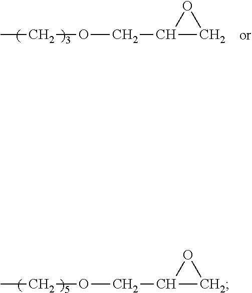

each R¹² is independently selected from the group consisting of a C₁-C₄ alkoxy group and a C₁-C₄ alkyl group;

each R¹³ is independently a C₁-C₄ alkyl group;

each R¹⁴ is independently selected from the group consisting of a C₁-C₄ alkoxy group and a C₁-C₄ alkyl group;

R¹⁵ represents

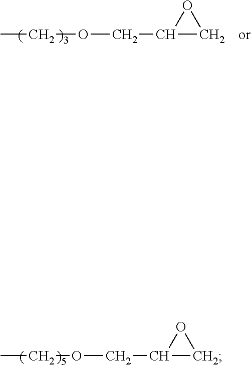

n represents an integer ranging from 35 to 150.

In certain embodiments, the first polysiloxane is the polysiloxane represented by the aforesaid formula (I),

in which

R¹¹ represents

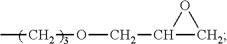

R¹² represents a C₁-C₄ alkoxy group;

R¹³ represents a C₁-C₄ alkyl group;

R14 represents a C₁-C₄ alkoxy group;

R15 represents

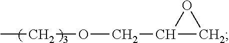

and

n represents an integer ranging from 35 to 60.

In certain embodiments, the first polysiloxane has a weight average molecular weight ranging from 3,000 to 25,000 g/mol. In an exemplary embodiment, in order to make the thermal interface composition have low viscosity, and make the thermal interface composition easy to be coated, the first polysiloxane has a weight average molecular weight ranging from 3,500 to 4,000 g/mol.

In certain embodiments, the first polysiloxane has a viscosity ranging from 80 cst to 10,000 cst. In an exemplary embodiment, in order to make the thermal interface composition have low viscosity, and make the thermal interface composition easy to be coated, the first polysiloxane has a viscosity ranging from 80 cst to 120 cst.

In certain embodiments, the first polysiloxane is present in an amount not lower than 50 wt % and not greater than 90 wt %, based on the total weight of the polysiloxane component. In an exemplary embodiment, the first polysiloxane is present in an amount ranging from 60 wt % to 90 wt %.

An example of the second polysiloxane may include, but is not limited to, a polysiloxane represented by formula (II):

R²¹Si(R²²)₂O[Si(R²³)₂O]ₘSi(R²⁴)₃ (II),

where R²¹ represents

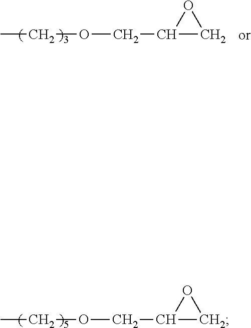

each R²² is independently a C₁-C₄ alkyl group;

each R²³ is independently a C₁-C₄ alkyl group;

each R²⁴ is independently a C₁-C₄ alkyl group; and

m represents an integer ranging from 9 to 80.

In certain embodiments, the second polysiloxane is the polysiloxane represented by formula (II) as described above, where R²¹ represents

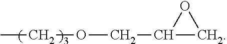

In certain embodiments, the second polysiloxane has a weight average molecular weight ranging from 1,000 to 5,000 g/mol. In certain embodiments, the second polysiloxane has a viscosity ranging from 10 cst to 120 cst.

In certain embodiments, the second polysiloxane is present in an amount not lower than 5 wt % and not greater than 40 wt, based on the total weight of the polysiloxane component. In an exemplary embodiment, the second polysiloxane is present in an amount ranging from 10 wt % to 40 wt&. In another exemplary embodiment, in order to make the thermal interface composition have flexibility and ductility during pressing and bonding, and make the thermal interface material prepared from the thermal interface composition have better shock absorption ability or elastic recovery rate, the second polysiloxane is present in an amount ranging from 10 wt % to 15 wt %.

### <Thermal Conductive Component>

In certain embodiments, the first thermal conductive filler is present in an amount not lower than 30 wt % and not greater than 50 wt %, based on the total weight of the thermal conductive component.

In an exemplary embodiment, the first thermal conductive filler is present in an amount not lower than 30 wt % and not greater than 40 wt %, based on the total weight of the thermal conductive component.

In certain embodiments, the second thermal conductive filler is present in an amount not lower than 30 wt % and not greater than 50 wt %, based on the total weight of the thermal conductive component.

In an exemplary embodiment, the second thermal conductive filler is present in an amount not lower than 30 wt % and not greater than 40 wt %, based on the total weight of the thermal conductive component. In certain embodiments, the third thermal conductive filler is present in an amount ranging from 20 wt % to 40 wt %, based on the total weight of the thermal conductive component.

In certain embodiments, the first thermal conductive filler, the second thermal conductive filler, and the third thermal conductive filler are independently selected from the group consisting of metals and metal oxides. In certain embodiments, the first thermal conductive filler, the second thermal conductive filler, and the third thermal conductive filler are independently selected from the group consisting of metals and metal oxides each having a thermal conductivity greater than 10 W/mK. In certain embodiments, the first thermal conductive filler, the second thermal conductive filler, and the third thermal conductive filler are independently a metal oxide having a thermal conductivity greater than 10 W/mK.

In certain embodiments, the metal may be selected from the group consisting of aluminum, copper, silver, and gold.

In certain embodiments, the metal oxide may be selected from the group consisting of alumina, zinc oxide, and magnesium oxide.

### <Curing Agent>

In certain embodiments, the curing agent may be selected from the group consisting of an acid anhydride curing agent, an aliphatic amine curing agent, an aromatic polyamine curing agent, and a polythiol curing agent. Examples of the acid anhydride curing agent may include, but are not limited to, maleic anhydride, succinic anhydride, phthalic anhydride, hexahydrophthalic anhydride, methylhexahydrophthalic anhydride, methyltetrahydrophthalic anhydride, mellitic anhydride, trimellitic anhydride, and pyromellitic dianhydride. Examples of the aliphatic amine curing agent may include, but are not limited to, diethylenetriamine, triethylenetetramine, and tetraethylenepentamine. Examples of the aromatic polyamine curing agent may include, but are not limited to, diethyltoluenediamine, m-phenylenediamine, m-xylylenediamine, 4,4′-diaminodiphenylmethane, and 4,4′-diaminodiphenyl sulfone. Examples of the polythiol curing agent may include, but are not limited to, pentaerythritol tetrakis(3-mercaptobutyrate), trimethylolpropane tris(3-mercaptopropionate), and pentaerythritol tetrakis(2-mercaptoacetate).

In certain embodiments, the curing agent is present in an amount ranging from 40 parts by weight to 70 parts by weight, based on 100 parts by weight of the polysiloxane component.

### <Curing Accelerator>

In certain embodiments, the curing accelerator may be selected from the group consisting of an anionic polymerization type amine curing accelerator and a cationic polymerization type curing accelerator. An example of the anionic polymerization type amine curing accelerator may include, but is not limited to, triethanolamine. Examples of the cationic polymerization type curing accelerator may include, but are not limited to, a boron trifluoride-amine complex, boron trifluoride, tin tetrachloride, and aluminum trichloride.

In certain embodiments, the curing accelerator is present in an amount greater than 0 parts by weight and not greater than 0.25 parts by weight, based on 100 parts by weight of the polysiloxane component.

### <Organosilicon Coupling Agent>

The organosilicon coupling agent can improve the compatibility between the polysiloxane component and the thermal conductive component, and can increase the degree of dispersion of the thermal conductive component in the polysiloxane component, thereby improving the thermal conductivity and heat resistance of the thermal interface material prepared from the thermal interface composition, and improving the adhesion between the thermal interface material and the semiconductor chip, the heat dissipation element or the cover. Examples of the organosilicon coupling agent may include, but are not limited to, acrylosiloxane, methacryloyloxysiloxane, aminosiloxane, mercaptosiloxane, and silane with an alkoxy group having 1 to 30 carbon atoms. In certain embodiments, the organosilicon coupling agent is present in an amount ranging from 1 part by weight to 2 parts by weight, based on 100 parts by weight of the thermal conductive component.

Examples of the acrylosiloxane may include, but are not limited to, 3-propenyloxypropyldimethylmethoxysilane (CH₂═CH—COO—CH₂CH₂CH₂—Si(OCH₃) (CH₃)₂) and 3-propenyloxypropyltrimethoxysilane (CH₂═CH—COO—CH₂CH₂CH₂—Si(OCH₃)₃). Examples of the methacryloyloxysiloxane may include, but are not limited to, 3-methacryloyloxypropyldimethylmethoxysilane (CH₂═C(CH₃)—COO—CH₂CH₂CH₂—Si(OCH₃) (CH₃)₂) and 3-methacryloyloxypropyltrimethoxysilane (CH₂═C(CH₃)—COO—CH₂CH₂CH₂—Si(OCH₃)₃). Examples of the aminosiloxane may include, but are not limited to, 3-aminopropyltrimethoxysilane (NH₂CH₂CH₂CH₂—Si(OCH₃)₃) and N-2-(aminoethyl)-3-aminopropylmethyldimethoxysilane ((NH₂CH₂CH₂)NH—CH₂CH₂CH₂—Si(CH₃) (OCH₃)₂). Examples of the mercaptosiloxane may include, but are not limited to, 3-mercaptopropyltrimethoxysilane (SH—CH₂CH₂CH₂—Si(OCH₃)₃), 3-mercaptopropyltriethoxysilane (SH—CH₂CH₂CH₂—Si(OCH₂CH₃)₃), 3-mercaptopropyldimethylmethoxysilane (SH—CH₂CH₂CH₂—Si(OCH₃) (CH₃)₂), and 3-mercaptopropyldiethylethoxysilane (SH—CH₂CH₂CH₂—Si(OCH₂CH₃) (CH₂CH₃)₂). Examples of the silane with an alkoxy group having 1 to 30 carbon atoms may include, but are not limited to, trimethoxysilane, triethoxysilane, tetraethoxysilane, and methyltrimethoxysilane.

### <Crosslinking Agent Having Three or More Epoxy Groups>

In certain embodiments, the crosslinking agent having three or more epoxy groups is present in an amount greater than 0.5 parts by weight and not greater than 0.7 parts by weight, based on 100 parts by weight of the polysiloxane component.

Examples of the crosslinking agent having three or more epoxy groups may include, but are not limited to, 1,3,5-triglycidyl-s-triazinetrione, N, N-diglycidyl-4-glycidyloxyaniline, trimethylolpropane triglycidyl ether, trimethylolethane triglycidyl ether, and tris(4-hydroxyphenyl)methane triglycidyl ether.

### <Method for Preparing Thermal Interface Material>

The present disclosure also provides a method for preparing a thermal interface material, which includes subjecting the aforesaid thermal interface composition to a curing reaction.

In certain embodiments, the curing reaction is conducted at a temperature ranging from 120° C.; to 150° C. In certain embodiments, the curing reaction is conducted for a time period ranging from 0.5 hour to 2 hours.

### <Thermal Interface Material>

The present disclosure provides a thermal interface material, which is prepared by the aforesaid method.

By virtue of the polysiloxane component, the thermal conductive component, the curing agent, the curing accelerator, the organosilicon coupling agent, and the crosslinking agent having three or more epoxy groups and the amounts thereof, the thermal interface material formed from the thermal interface composition can return to its original state without deformation after being subjected to an external force. Therefore, the adhesion between the thermal interface material and the semiconductor chip can be maintained, thereby achieving thermal conductivity effect. In addition, the thermal interface material can absorb external forces and protect the semiconductor chip from being damaged by external forces.

The present disclosure will be further described by way of the following examples. However, it should be understood that the following examples are intended solely for the purpose of illustration and should not be construed as limiting the present disclosure in practice.

### Examples

### Example 1 (EX1):

### Materials:

### A. Polysiloxane Component

The polysiloxane component used in the following experiments contained 90 wt % of (epoxypropoxypropyl)dimethoxysilyl terminated polydimethylsiloxane

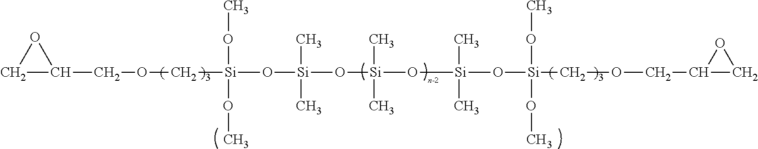

(serving as a first polysiloxane; CAS No. 188958-73 8; weight average molecular weight: 3800 g/mol; viscosity: 100 cst; n−2=43) and 10 wt % of mono-(2,3-epoxy)propylether terminated polydimethylsiloxane

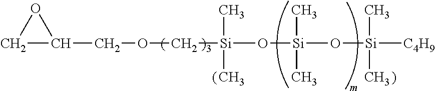

(serving as a second polysiloxane; CAS No. 127947-26-6; weight average molecular weight: 3000 g/mol; viscosity: 62 cst; m=36).

### B. Thermal Conductive Component

The thermal conductive component used in the following experiments contained 40 wt % of alumina having an average particle size of 10 μm (serving as a first thermal conductive filler), 40 wt % of alumina having an average particle size of 1 μm (serving as a second thermal conductive filler), and 20 wt % of alumina having an average particle size of 0.2 μm (serving as a third thermal conductive filler).

### Methods:

100 parts by weight (referred to as “pbw” hereinafter) of the polysiloxane component described in section A of “Materials”, 1000 pbw of the thermal conductive component described in section B of “Materials”, 60 pbw of maleic anhydride (serving as a curing agent), 0.1 pbw of triethanolamine (serving as a curing accelerator), 12 pbw of methacryloyloxypropyltrimethoxysilane (serving as an organosilicon coupling agent), and 0.7 pbw of 1,3,5-triglycidyl-s-triazinetrione (serving as a crosslinking agent having three or more epoxy groups) were mixed homogeneously, so as to obtain a thermal interface composition. Next, the thermal interface composition was subjected to a curing reaction at 135° C. for 70 minutes, so as to obtain a thermal interface material.

### Examples 2 to 7 (EX2 to EX7) and Comparative Examples 1 to 10 (CE1 to CE10):

The procedures for preparing the thermal interface compositions and thermal interface materials of EX2 to EX7 and CE1 to CE10 were similar to those of EX1, except that the amounts of the first polysiloxane and the second polysiloxane used for making the polysiloxane component, the amounts of the first to third thermal conductive fillers used for making the thermal conductive component, and the amount of the crosslinking agent were varied as shown in Tables 1 and 2 below.

TABLE 1

| | | EX | | | | | | | CE |
|---|---|---|---|---|---|---|---|---|---|
| | | 1 | 2 | 3 | 4 | 5 | 6 | 7 | 1 |
| Polysiloxane | First polysiloxane | 90 | 60 | 90 | 95 | 85 | 90 | 90 | 100 |
| component | (wt %) | | | | | | | | |
| | Second polysiloxane | 10 | 40 | 10 | 5 | 15 | 10 | 10 | 0 |
| | (wt %) | | | | | | | | |
| | Total amount | 100 | 100 | 100 | 100 | 100 | 100 | 100 | 100 |
| | (pbw) | | | | | | | | |
| Thermal | First thermal | 40 | 40 | 40 | 40 | 40 | 40 | 40 | 40 |
| conductive | conductive filler | | | | | | | | |
| component | (wt %) | | | | | | | | |
| | Second thermal | 40 | 40 | 40 | 40 | 40 | 40 | 40 | 40 |
| | conductive filler | | | | | | | | |
| | (wt %) | | | | | | | | |
| | Third thermal | 20 | 20 | 20 | 20 | 20 | 20 | 20 | 20 |
| | conductive filler | | | | | | | | |
| | (wt %) | | | | | | | | |
| | Total amount | 1000 | 1000 | 1200 | 1000 | 1000 | 600 | 1000 | 1000 |
| | (pbw) | | | | | | | | |
| | Specific surface | 2.56 | 2.56 | 2.56 | 2.56 | 2.56 | 2.56 | 2.56 | 2.56 |
| | area (m²/g) | | | | | | | | |
| Curing | Maleic anhydride | 60 | 60 | 60 | 60 | 60 | 60 | 60 | 60 |
| agent | (pbw) | | | | | | | | |
| Curing | Triethanolamine | 0.1 | 0.1 | 0.1 | 0.1 | 0.1 | 0.1 | 0.1 | 0.1 |
| accelerator | (pbw) | | | | | | | | |
| Organosilicon | Methacryloyloxypropyl- | 12 | 12 | 12 | 12 | 12 | 12 | 12 | 12 |
| coupling | trimethoxysilane | | | | | | | | |
| agent | (pbw) | | | | | | | | |
| Crosslinking | 1,3,5-triglycidyl- | 0.7 | 0.7 | 0.7 | 0.7 | 0.7 | 0.7 | 0.9 | 0.7 |
| agent | s-triazinetrione | | | | | | | | |
| | (pbw) | | | | | | | | |

TABLE 2

| | | CE | | | | | | | | |
|---|---|---|---|---|---|---|---|---|---|---|
| | | 2 | 3 | 4 | 5 | 6 | 7 | 8 | 9 | 10 |
| Polysiloxane | First polysiloxane | 45 | 90 | 90 | 90 | 90 | 90 | 90 | 90 | 90 |
| component | (wt %) | | | | | | | | | |
| | Second polysiloxane | 55 | 10 | 10 | 10 | 10 | 10 | 10 | 10 | 10 |
| | (wt %) | | | | | | | | | |
| | Total amount | 100 | 100 | 100 | 100 | 100 | 100 | 100 | 100 | 100 |
| | (pbw) | | | | | | | | | |
| Thermal | First thermal | 40 | 25 | 0 | 60 | 60 | 40 | 40 | 40 | 40 |
| conductive | conductive filler | | | | | | | | | |
| component | (wt %) | | | | | | | | | |
| | Second thermal | 40 | 25 | 60 | 0 | 40 | 40 | 40 | 40 | 40 |
| | conductive filler | | | | | | | | | |
| | (wt %) | | | | | | | | | |
| | Third thermal | 20 | 50 | 40 | 40 | 0 | 20 | 20 | 20 | 20 |
| | conductive filler | | | | | | | | | |
| | (wt %) | | | | | | | | | |
| | Total amount | 1000 | 1000 | 1000 | 1000 | 1000 | 1500 | 1000 | 1000 | 1000 |
| | (pbw) | | | | | | | | | |
| | Specific surface | 2.56 | 4.23 | 4.30 | 3.04 | 1.24 | 2.56 | 2.56 | 2.56 | 2.56 |
| | area (m²/g) | | | | | | | | | |
| Curing | Maleic anhydride | 60 | 60 | 60 | 60 | 60 | 60 | 60 | 60 | 60 |
| agent | (pbw) | | | | | | | | | |
| Curing | Triethanolamine | 0.1 | 0.1 | 0.1 | 0.1 | 0.1 | 0.1 | 0.1 | 0.1 | 0.1 |
| accelerator | (pbw) | | | | | | | | | |
| Organosilicon | Methacryloyloxypropyl- | 12 | 12 | 12 | 12 | 12 | 12 | 12 | 12 | 12 |
| coupling | trimethoxysilane | | | | | | | | | |
| agent | (pbw) | | | | | | | | | |
| Crosslinking | 1,3,5-triglycidyl- | 0.7 | 0.7 | 0.7 | 0.7 | 0.7 | 0.7 | 0 | 0.5 | 2 |
| agent | s-triazinetrione | | | | | | | | | |
| | (pbw) | | | | | | | | | |

### Property Evaluation:

A respective one of the thermal interface compositions of EX1 to EX7 and CE1 to CE10 was used as a test sample, and was subjected to the analyses as described in section A below. In addition, the respective one of the thermal interface materials of EX1 to EX7 and CE1 to CE10 was used as a test sample, and was subjected to the analyses as described in section B to section D below.

### A. Measurement of Storage Elastic Modulus Value:

The respective test sample (i.e., the thermal interface composition) was coated between two parallel plates each with a diameter of 2.5 cm to form a coating film with a thickness of 2 mm. Next, the coating film was heated at a heating rate of 5° C./min until reaching a temperature of 150° C., followed by conducting a curing reaction at 150° C. for 2 hours, so as to obtain a thermal interface material. The storage elastic modulus value of the respective thermal interface material was measured using a dynamic mechanical analyzer (Manufacturer: Rheometric Scientific; Catalogue no.: RDA III). The results are shown in Tables 3 to 4 below.

### B. Measurement of Thermal Conductivity:

The thermal conductivity of the respective test sample (i.e., the thermal interface material) was measured at 40° C. under a pressure of 20 psi using a Tim thermal resistance and conductivity measurement apparatus (Manufacturer: Long-Win Science & Technology Corporation; Catalogue no.: LW-9389) in accordance with ASTM D5470-06 (published in 2016). The results are shown in Tables 3 to 4 below.

### C. Measurement of Elastic Recovery Rate:

The elastic recovery rate of the respective test sample (i.e., the thermal interface material) was measured using a compression and deformation tester (Manufacturer: Ying-Jia Co., Ltd.; Catalogue no.: JIA-915) in accordance with ASTM D395 (published in 2008). Briefly, the test sample having an original thickness (To) was placed on a test piece (diameter: 25 mm; thickness: 10 mm), and the test piece was then sandwiched between two flat plates of the compression and deformation tester. Next, the test sample was compressed such that a thickness thereof was 25 of the original thickness by tightening the screws to shorten the distance between the two flat plates. After compression at 150° C. for 22 hours, the compressed thickness (Tᵢ) of the test sample was measured. Thereafter, the test piece was removed and cooled for 30 minutes, and the recovery thickness (T_{f}) of the test sample was measured.

The elastic recovery rate of the test sample was calculated using the following Equation (I):

Elastic recovery rate (%)=[(T₀−T_{f})/(T₀−Tᵢ)]×100% (I)

The test was repeated for 2 times, and an average value was calculated and presented in Tables 3 to 4 below.

### D. Measurement of Resilience:

The resilience of the respective test sample (i.e., the thermal interface material) was measured using a rebound resilience tester (Manufacturer: Gotech Testing Machines Inc.; Catalogue no.: GT-7042-R) in accordance with JIS K6255 (published in 1996). Briefly, an iron bar of the rebound resilience tester was moved, so that a pointer of the rebound resilience tester was at the position of 100 on the scale, followed by allowing the iron bar fall freely to hit the test sample, and the rebound height of the iron bar was visually observed and measured using a ruler.

The test was repeated for 6 times, the 4th to 6th rebound height values were recorded, and an average value was calculated and presented in Tables 3 and 4 below.

TABLE 3

| | EX | | | | | | | CE |
|---|---|---|---|---|---|---|---|---|
| | 1 | 2 | 3 | 4 | 5 | 6 | 7 | 1 |
| Storage elastic | 158 | 98 | 174 | 198 | 132 | 133 | 137 | 287 |
| modulus value (MPa) | | | | | | | | |
| Thermal conductivity | 2.8 | 2.7 | 3.1 | 2.8 | 2.8 | 2.2 | 2.8 | 2.8 |
| (W/mK) | | | | | | | | |
| Average elastic | 16 | 24 | 23 | 20 | 23 | 20 | 18 | 30 |
| recovery rate (%) | | | | | | | | |
| Resilience (%) | 27 | 24 | 24 | 30 | 25 | 30 | 30 | 37 |

TABLE 4

| | CE | | | | | | | | |
|---|---|---|---|---|---|---|---|---|---|
| | 2 | 3 | 4 | 5 | 6 | 7 | 8 | 9 | 10 |
| Storage elastic | — | — | 279 | 178 | 166 | 162 | 103 | 114 | 325 |
| modulus value (MPa) | | | | | | | | | |
| Thermal conductivity | — | — | 2.1 | 2.2 | 2.5 | 3.5 | 2.9 | 2.9 | 2.7 |
| (W/mK) | | | | | | | | | |
| Average elastic | — | — | 30 | 32 | 28 | 32 | 37 | 21 | — |
| recovery rate (%) | | | | | | | | | |
| Resilience (%) | — | — | 41 | 36 | 39 | 25 | 36 | 32 | — |

“—”: Not determined due to the thermal interface material was in powder form or cracked.

### Results:

As shown in Tables 3 and 4, by virtue of the polysiloxane component, the thermal conductive component, the curing agent, the curing accelerator, the organosilicon coupling agent, and the crosslinking agent having three or more epoxy groups and the amounts thereof, a respective one of the thermal interface materials of EX1 to EX7 had low average elastic recovery rate and resilience. This result indicates that a respective one of the thermal interface materials of EX1 to EX7 can return to its original state without deformation after being subjected to an external force, and can absorb the external force and protect the semiconductor chip from being damaged by the external force.

The experimental results of the aforesaid tests performed on the thermal interface materials of CE1 to CE10 are discussed below.

On the contrary, the thermal interface material of CE1 was prepared from the thermal interface composition without a second polysiloxane, and thus had high average elastic recovery rate and resilience, indicating that the thermal interface material of CE1 cannot return to its original state after being impacted by an external force and cannot absorb the external force.

The thermal interface material of CE2 was prepared from the thermal interface composition containing the first polysiloxane in an amount of lower than 50 wt %, and thus could not form a desired shape after the curing reaction.

The thermal interface material of CE3 was prepared from the thermal interface composition containing the first thermal conductive filler in an amount of lower than 30 wt %, the second thermal conductive filler in an amount of lower than 30 wt %, and the third thermal conductive filler in an amount of not lower than 40 wt, and thus could not form a desired shape after the curing reaction.

The thermal interface materials of CE4 to CE6 were prepared from the thermal interface compositions containing any two of the first thermal conductive filler, the second thermal conductive filler, and the third thermal conductive filler, and thus had high average elastic recovery rate and resilience, indicating that the thermal interface materials of CE4 to CE6 cannot return to their original state after being impacted by an external force and cannot absorb the external force.

The thermal interface material of CE7 was prepared from the thermal interface composition containing 1500 parts by weight of the thermal conductive component, and thus had a high average elastic recovery rate, indicating that the thermal interface material of CE7 cannot return to its original state after being impacted by an external force.

The thermal interface material of CE8 was prepared from the thermal interface composition without a crosslinking agent, and thus had high average elastic recovery rate and resilience, indicating that the thermal interface material of CE8 cannot return to its original state after being impacted by an external force and cannot absorb the external force.

The thermal interface material of CE9 was prepared from the thermal interface composition containing 0.5 parts by weight of the crosslinking agent, and thus had a high resilience, indicating that the thermal interface material of CE9 cannot absorb an external force after being impacted by the external force.

The thermal interface material of CE10 was prepared from the thermal interface composition containing 2 parts by weight of the crosslinking agent, and thus had a problem of cracking after being impacted by an external force.

Summarizing the above test results, it is clear that by virtue of the polysiloxane component, the thermal conductive component, the curing agent, the curing accelerator, the organosilicon coupling agent, and the crosslinking agent having three or more epoxy groups and the amounts thereof, the thermal interface material formed from the thermal interface composition can return to its original state without deformation after being subjected to an external force. Therefore, the adhesion between the thermal interface material and the semiconductor chip can be maintained, thereby achieving thermal conductivity effect. In addition, the thermal interface material can absorb an external force and protect the semiconductor chip from being damaged by the external force.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A thermal interface composition, comprising:
a polysiloxane component which includes a first polysiloxane having epoxy groups at opposite ends and a second polysiloxane having an epoxy group at one end, the first polysiloxane being present in an amount not lower than 50 wt % and lower than 100 wt %, based on a total weight of the polysiloxane component;
a thermal conductive component which includes, based on the total weight of the thermal conductive component, not lower than 30 wt and lower than 70 wt % of a first thermal conductive filler that has a particle size greater than 1 μm and not greater than 10 μm, not lower than 30 wt % and lower than 70 wt % of a second thermal conductive filler that has a particle size greater than 0.2 μm and not greater than 1 μm, and greater than 0 wt and not greater than 40 wt % of a third thermal conductive filler that has a particle size not greater than 0.2 μm;
a curing agent;
a curing accelerator;
an organosilicon coupling agent for improving compatibility between the polysiloxane component and the thermal conductive component; and
a crosslinking agent having three or more epoxy groups;
wherein the thermal conductive component is present in an amount not lower than 600 parts by weight and lower than 1500 parts by weight, and the crosslinking agent is present in an amount greater than 0.5 parts by weight and not greater than 0.9 parts by weight, based on 100 parts by weight of the polysiloxane component.

2. The thermal interface composition according to claim 1, wherein the first polysiloxane is a polysiloxane represented by formula (I):
R¹¹Si(R¹²)₂O[Si(R¹³)₂O]ₙSi(R¹⁴)₂R¹⁵ (I),
in which
R¹¹ represents 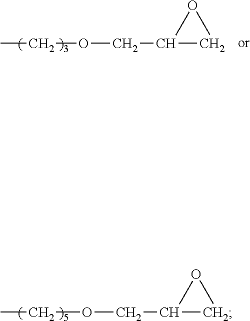
each R¹² is independently selected from the group consisting of a C₁-C₄ alkoxy group and a C₁-C₄ alkyl group;
each R¹³ is independently a C₁-C₄ alkyl group;
each R¹⁴ is independently selected from the group consisting of a C₁-C₄ alkoxy group and a C₁-C₄ alkyl group;
R¹⁵ represents 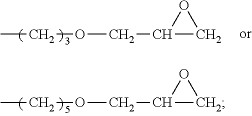
n represents an integer ranging from 35 to 150.

3. The thermal interface composition according to claim 1, wherein the second polysiloxane is a polysiloxane represented by formula (II):
R²¹Si(R²²)₂O[Si(R²³)₂O]ₘSi(R²⁴)₃ (II),
in which
R²¹ represents 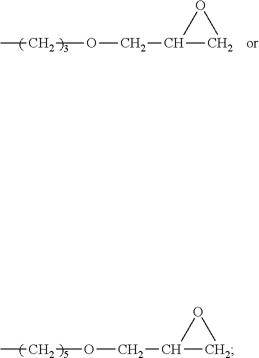
each R²² is independently a C₁-C₄ alkyl group;
each R²³ is independently a C₁-C₄ alkyl group;
each R²⁴ is independently a C₁-C₄ alkyl group; and
m represents an integer ranging from 9 to 80.

4. The thermal interface composition according to claim 1, wherein the crosslinking agent having three or more epoxy groups is selected from the group consisting of 1,3,5-triglycidyl-s-triazinetrione, N,N-diglycidyl-4-glycidyloxyaniline, trimethylolpropane triglycidyl ether, trimethylolethane triglycidyl ether, tris(4-hydroxyphenyl)methane triglycidyl ether, and combinations thereof.

5. The thermal interface composition according to claim 1, wherein the first thermal conductive filler, the second thermal conductive filler, and the third thermal conductive filler are independently selected from the group consisting of metals and metal oxides.

6. The thermal interface composition according to claim 5, wherein the metal oxide is selected from the group consisting of alumina, zinc oxide, and magnesium oxide.

7. The thermal interface composition according to claim 5, wherein the metal is selected from the group consisting of aluminum, copper, silver, and gold.

8. The thermal interface composition according to claim 1, wherein the curing accelerator is selected from the group consisting of an anionic polymerization type amine curing accelerator and a cationic polymerization type curing accelerator.

9. A method for preparing a thermal interface material, comprising subjecting a thermal interface composition as claimed in claim 1 to a curing reaction.

10. A thermal interface material, which is prepared by a method according to claim 9.
